(19) United States
(12) Patent Application Publication
(10) Pub. No.: US 2021/0123509 A1
(43) Pub. Date: Apr. 29, 2021

(54) PISTON SIDE HOLE ORIENTATION IN A HYDRAULIC TENSIONER WITH AN INTERNAL RESERVOIR

(71) Applicant: BorgWarner Inc., Auburn Hills, MI (US)

(72) Inventor: Toshinobu Kimura, Sakurai-City (JP)

(21) Appl. No.: 16/665,616

(22) Filed: Oct. 28, 2019

(51) Int. Cl. F16H 7/08

(52) U.S. Cl. CPC F16H 7/08; F16H 2007/0891; F16H 2007/0817

(57) ABSTRACT

A position of a reservoir hole of a hollow piston of a hydraulic tensioner is downside of a centerline or center plane of the piston to increase the oil retention within the internal reservoir during engine shutdown, reduce start up noise and decrease air from accumulating within the internal reservoir.

### BACKGROUND OF THE INVENTION

### Field of the Invention

The invention pertains to the field of hydraulic tensioners. More particularly, the invention pertains to a piston side hole orientation for a hydraulic tensioner with an internal reservoir.

### Description of Related Art

FIG. 1 shows a conventional reservoir type hydraulic tensioner 10. A housing 2 has a closed end bore 3 which receives a hollow piston 4. Along the length of the bore 3 is an oil inlet feed 5 that is in fluid communication with an oil supply. The hollow piston 4 is received within the closed end bore 3 of the housing 2. The hollow piston 4 has a centerline or center plane C-C. Along the length of the body of the piston 4 is a reservoir hole 40 that allows the entry and exit of fluid from a reservoir 41 formed within the hollow interior 4c of the piston 4. Also present within the closed end bore 3 is a check valve assembly 20, a washer 43, a high pressure chamber 8 formed between the bore 3, the internal interior 4c of the piston 4, and the check valve assembly 20. A piston spring 7 is present between the check valve assembly 20 and the closed end bore 3 within the high pressure chamber 8. The conventional reservoir type hydraulic tensioner 10 is mounted within engine such that as the piston 4 slidably moves within the closed end bore 3, the reservoir hole 40 of the piston 4 is aligned with the oil inlet feed 5 of the housing 2, since the reservoir hole 40 is above the center plane C-C of the hollow piston 4 when the tensioner housing 2 is mounted to the engine block. During engine stop condition, for example when oil supply from the engine is zero, fluid can flow from the internal reservoir 41 to the oil inlet 5 through the reservoir hole 40 and flow to atmosphere through the piston housing clearance. Additionally, air can flow from the oil inlet 5 into the internal reservoir 41.

### SUMMARY OF THE INVENTION

A position of a reservoir hole of a hollow piston of a hydraulic tensioner is downside of a center plane of the piston to increase the oil retention within the internal reservoir during engine shutdown, reduce start up noise, and decrease air from accumulating within the internal reservoir.

### BRIEF DESCRIPTION OF THE DRAWING

FIG. 1 shows a conventional reservoir type hydraulic tensioner mounted within an engine.

FIG. 2 shows a schematic of a reservoir type hydraulic tensioner of an embodiment of the present invention.

FIG. 3 shows a schematic of the reservoir type hydraulic tensioner of FIG. 2 in an orientation as mounted in an internal combustion engine.

FIG. 4 shows the piston of the reservoir type hydraulic tensioner of FIG. 2 with an additional vent.

FIG. 5 shows a schematic of a reservoir type hydraulic tensioner of a second embodiment of the present invention.

FIG. 6 shows the piston of the reservoir type hydraulic tensioner of FIG. 5 with an additional vent.

FIG. 7 shows a schematic of reservoir type hydraulic tensioner of a third embodiment of the present invention.

### DETAILED DESCRIPTION OF THE INVENTION

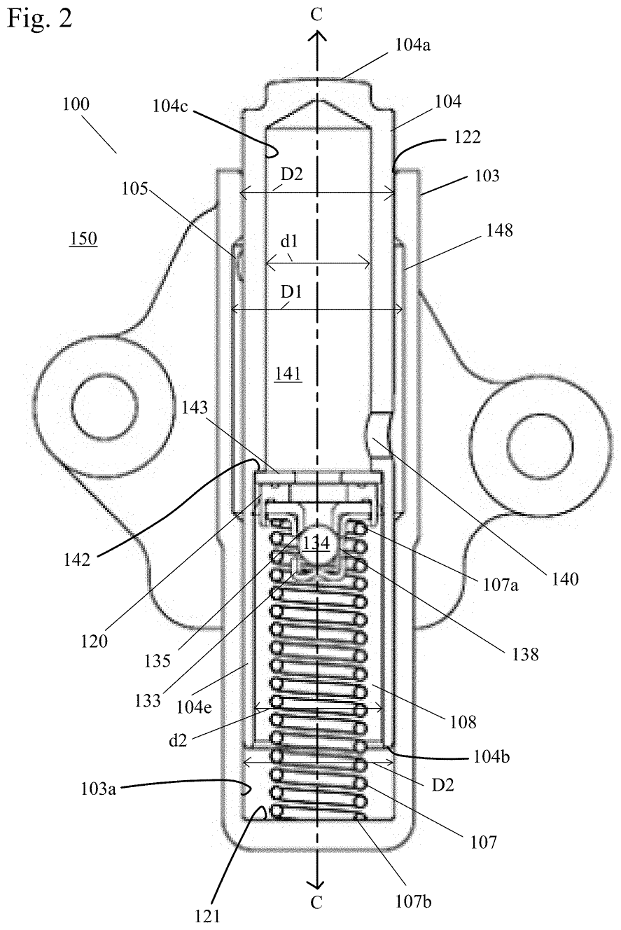

The hydraulic tensioner 100, 200 of FIGS. 2-7 can be used for an endless loop, flexible, power transmission member for an internal combustion engine of a motor vehicle, such as a chain or belt. The power transmission member can encircle a drive sprocket driven by a drive shaft, such as a crankshaft of the engine, and the at least one driven sprocket can be supported from a driven shaft, such as a camshaft of the engine.

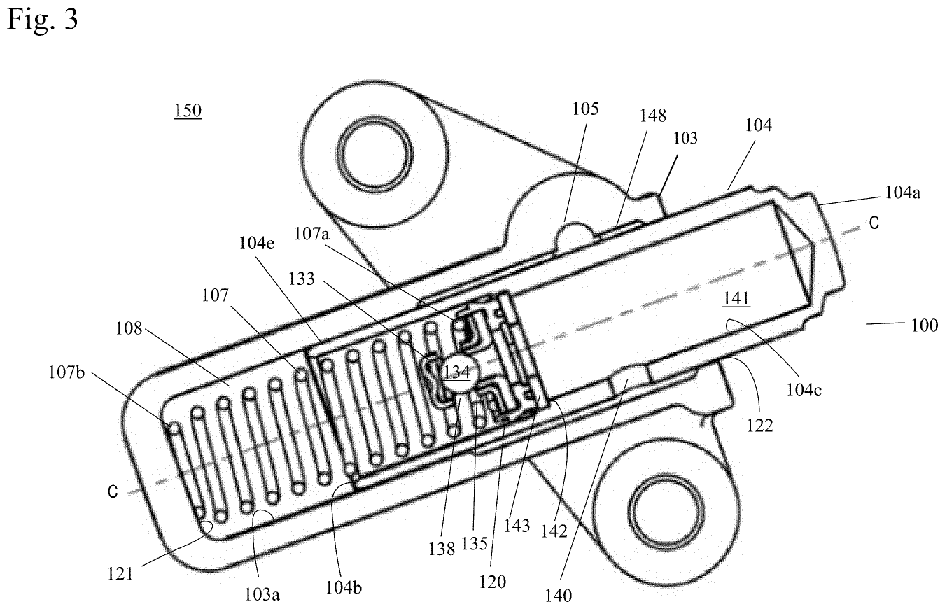

FIGS. 2-3 show a reservoir type hydraulic tensioner of a first embodiment. The reservoir type hydraulic tensioner 100 is mounted to an engine block 150 of an internal combustion engine via bolts or screws (not shown). The tensioner housing 103 has a closed end multistage internal bore 103a. Between a closed end 121 of the bore 103a and an open end 122 of the bore 103a is a first diameter portion D1 and a second diameter portion D2. The second diameter portion D2 is present at the closed end 121 of the of the bore 103a and the open end of the bore 103a. The first diameter portion D1 is present adjacent the second diameter portion D2 at the open end 122 of the bore 103a and the second diameter portion D2 at the closed end 121 of the bore 103a. The first diameter portion D1 is greater in diameter the second diameter portion D2. An oil inlet 105 for the hydraulic tensioner 100 is present along the first diameter portion Dl. The first diameter portion D1 corresponds to an inlet portion 148 of the bore. The oil inlet 105 is in fluid communication with an oil supply.

A hollow piston 104 is slidably received within the bore 103a of the housing 103. The hollow piston 104 has a body 104e with a first end 104a and a second end 104b defining an internal bore 104c and a center plane C-C. The first end 104a of the hollow piston 104 contacts a tensioner body, guide, or endless loop flexible power transmission member for an internal combustion engine. The second end 104b of the hollow piston 104 is received within the closed end 121 of the bore 103a. Along the body 104e of the hollow piston 104, between the first end 104a and the second end 104b is a reservoir hole 140. The reservoir hole 140 is below the center plane C-C of the piston 104 when the tensioner housing 103 is mounted to the engine block 150. Therefore, the reservoir hole 140 of the hollow piston 104 and the oil inlet 105 are on opposite sides of the piston center plane C-C. The hollow piston 104 defines an internal bore or reservoir 141. The internal reservoir 141 has a first internal diameter dl and a second internal diameter d2. The first internal diameter dl is less than the second internal diameter d2. A shoulder 142 is present between the first internal diameter dl and the second internal diameter d2.

Received within the second internal diameter d2 and adjacent the shoulder 142 is a washer 143 and a check valve assembly 120. The check valve assembly 120 has a retainer 133 which creates a cavity in which ball 134 can move and seat on or off of valve seat 135. The shape of the retainer 133 is not limited to the shape shown in the drawings. Furthermore, the ball 134 can be another shape such as a disk or cup and is not limited to the shape shown in the drawings. The check valve assembly 120 further defines the internal reservoir 141 and separates the internal reservoir 141 from a high pressure chamber 108 formed within the closed end 121 of the bore 103a, the second end 104b of the piston 104 and a portion of the internal reservoir 141.

In a closed position of the check valve assembly 120, fluid is prevented from entering the high pressure chamber 108 by the ball 134 seating on the valve seat 135. In an open position, the ball 134 unseats from the valve seat 135, unblocking a hole 138 in the retainer 133, such that fluid in the internal reservoir 141 can flow around the ball 134, through the hole 138 and into the high pressure chamber 108.

A tensioner spring 107 is received within the high pressure chamber 108 with a first end 107a adjacent the check valve assembly 120 and a second end 107b adjacent the closed end 121 of the bore 103a of the housing 103. The tensioner spring 107 biases the against a retainer 133 of the check valve assembly 120 and pushes the piston 104 out and away from the closed end 121 of the bore 103a of the tensioner housing 102.

When pressure in the internal reservoir 141 is greater than the pressure in the high pressure chamber 108, the pressure of the internal reservoir 141 biases the moveable ball 134, allowing fluid from the internal reservoir 141 to flow into the high pressure chamber 108.

Fluid from a supply flows from an inlet 105 to the inlet portion 148 of the bore 103a and to the inlet 140 of the hollow piston 104. The fluid fills the internal reservoir 141 of the hollow piston 104. When the fluid in the internal reservoir 141 is of a pressure which is greater than the pressure in the high pressure chamber 108, fluid flows through the washer 143 and a hole in the retainer 133 into the high pressure chamber 108. Backflow from the high pressure chamber 108 to the internal reservoir 141 is prevented by ball 134. Fluid from the internal reservoir 141 can enter the high pressure chamber 108 when the pressure in the high pressure chamber 108 falls due to extension of the piston 104 outwards from the housing 103 (increasing the volume of the high pressure chamber 108), drawing fluid into the high pressure chamber 108 from the internal reservoir 141.

When the piston 104 is pushed towards the housing 103 in response to a pulse from the chain or belt, the pressure in the high pressure chamber 108 increases to react to the force applied from the chain. This pressure can be tuned to react to a known force to control the timing drive.

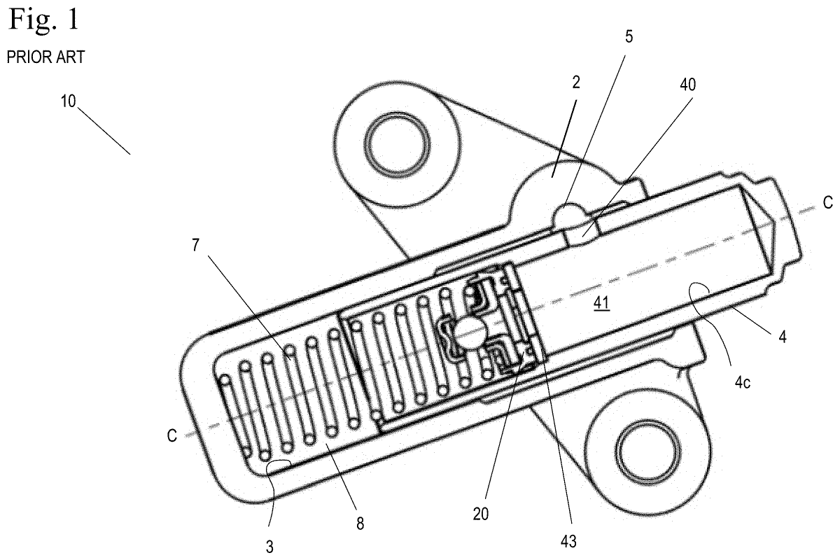

The hydraulic tensioner 100 of the present invention is installed on the engine block at an angle as shown in FIG. 3. In comparison to the prior art and as shown in FIG. 1, the hydraulic tensioner of present invention, when mounted at an angle, keeps small leakage of fluid from the internal reservoir 141 through the piston housing 103 clearance, as air is not able to invade the internal reservoir 141 because air cannot travel through the inlet portion 148 of the bore 103a filled with oil around the reservoir hole 140.

This is especially important during the engine stop condition when oil supply from the engine is zero.

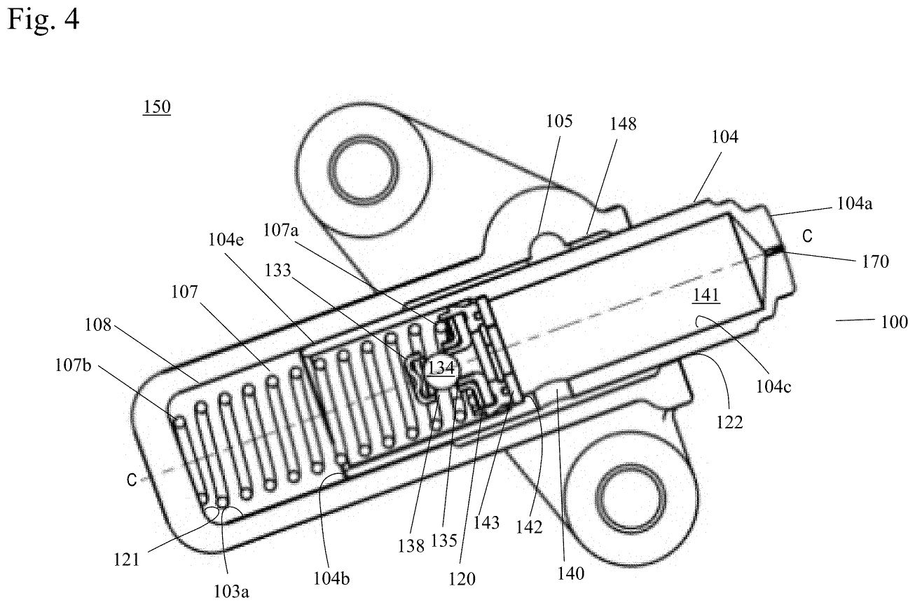

FIG. 4 shows the piston of the reservoir type hydraulic tensioner of FIG. 2 with an additional vent. An additional vent 170 to allow air to escape the internal reservoir 141 can be present in the first end 104a of the hollow piston 104. The vent 170 is preferably a small hole or a tortuous path within the first end 104a of the hollow piston 104 extending from the internal reservoir 141 to the external to the hollow piston 104.

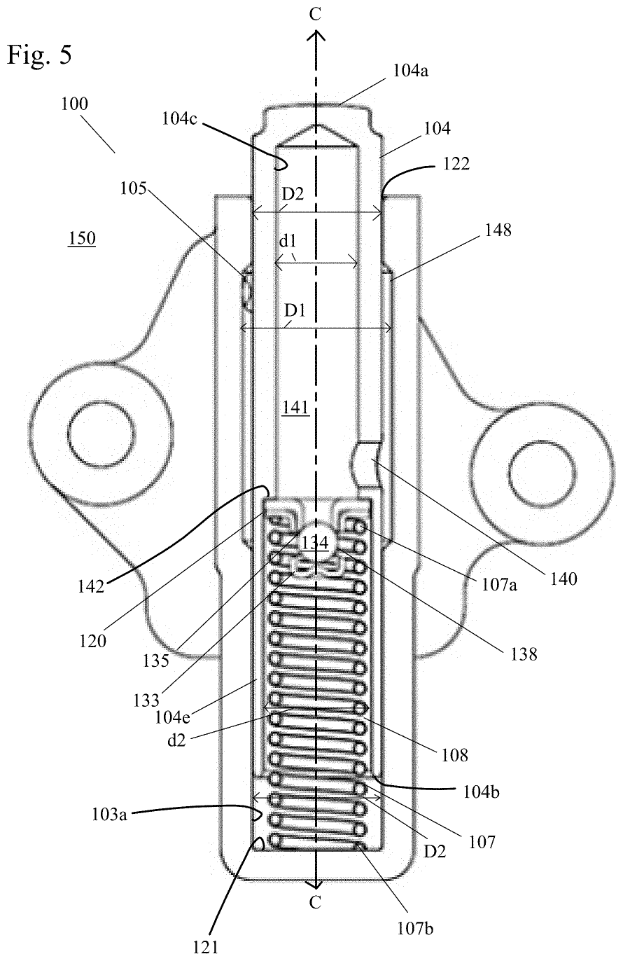

FIG. 5 shows a schematic of a reservoir type hydraulic tensioner of a second embodiment of the present invention. The difference between the reservoir type hydraulic tensioner of the first embodiment and the second embodiment is the removal of washer 143. Instead of the washer 143 being adjacent the shoulder 142 of the hollow piston 104, the retainer of the check valve assembly 120 is adjacent the shoulder 142.

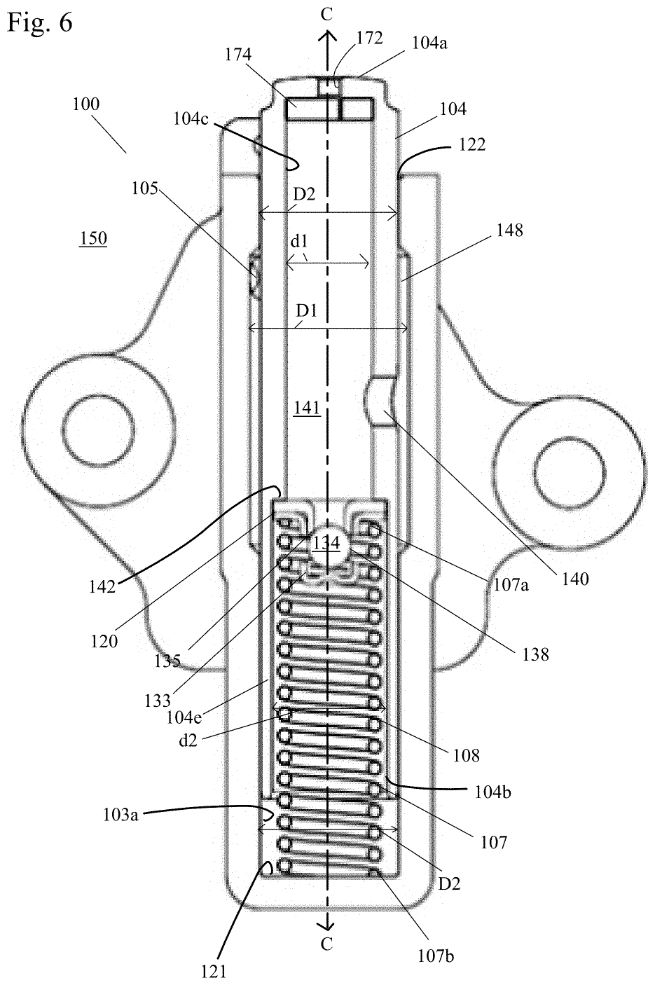

FIG. 6 shows the piston of the reservoir type hydraulic tensioner of FIG. 5 with an additional vent and a vent disk. A vent 172 is present within the first end 104a of the hollow piston 104 to allow air to escape the internal reservoir 141. A vent disk 174 is additionally present within the internal reservoir 141 adjacent the first end to aid in eliminating air from the internal reservoir 141.

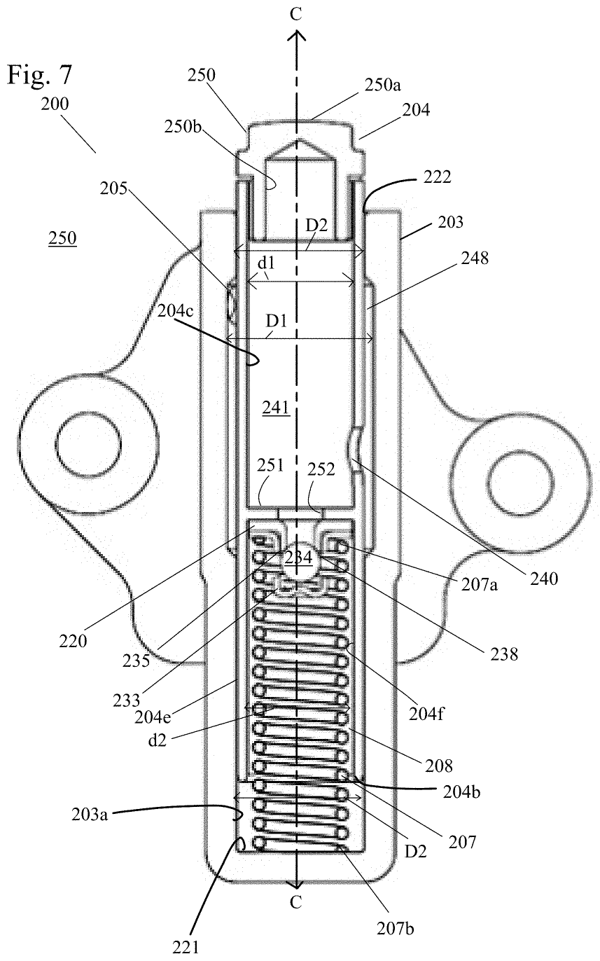

FIG. 7 shows a schematic of reservoir type hydraulic tensioner of a third embodiment of the present invention. The reservoir type hydraulic tensioner 200 is mounted to an engine block 250 of an internal combustion engine via bolts or screws (not shown). The tensioner housing 203 has a closed end multistage internal bore 203a with a closed end 221 and an open end 222. Between a closed end 221 of the bore 203a and an open end 222 of the bore 203a is a first diameter portion D1 and a second diameter portion D2. The second diameter portion D2 is present at the closed end 221 of the of the bore 203a and the open end of the bore 203a. The first diameter portion D1 is present adjacent the second diameter portion D2 at the open end 222 of the bore 203a and the second diameter portion D2 at the closed end 221 of the bore 203a. The first diameter portion D1 is greater in diameter the second diameter portion D2. An oil inlet 205 for the hydraulic tensioner 200 is present along the first diameter portion Dl. The first diameter portion D1 corresponds to an inlet portion 248 of the bore. The oil inlet 205 is in fluid communication with an oil supply.

A hollow piston 204 is slidably received within the bore 203a of the tensioner housing 203. The hollow piston 204 is formed of a body 204e and a cap 250 which has an internal bore 250b. The body 204e of the hollow piston 204 has a first end 204a, a second end 204b, a first internal bore 204c, an internal divider 251 with a central hole 252, and a center plane C-C, and a second internal bore 204f. The cap 250 has a surface 250a that contacts a tensioner body, guide, or endless loop flexible power transmission member for an internal combustion engine and is received within the first end 204a of the body 204e. An internal reservoir 241 is defined between the internal bore 250a of cap 250, the first internal bore 204c of the body 204e of the hollow piston 204, and the internal divider 251. Along the length of body 204e of the hollow piston 204, between the first end 204a and the second end 204b is a reservoir hole 240 that is in fluid communication with the internal reservoir 241. The reservoir hole 240 is below center plane C-C of the piston 204 when the tensioner housing 203 is mounted to the engine block 250. Therefore, the reservoir hole 240 of the hollow piston 204 is down side (below) the center plane C-C of the piston.

The second end 204b of the body 204e is received within the closed end 221 of the bore 203a. A high pressure chamber 208 is formed between the internal divider 251, the second internal bore 204f, and the closed end 221 of the bore 203a. A check valve assembly 220 is also received within high pressure chamber 208 adjacent the internal divider 251.

A tensioner spring 207 is present within the high pressure chamber 208 with a first end 207a of the tensioner spring 207 adjacent a retainer 233 of the check valve assembly 220 and a second end 207b of the tensioner spring adjacent the closed end 221 of the bore 203a. The tensioner spring 207 biases against a retainer 233 of the check valve assembly 220 and pushes the piston 204 out and away from the closed end 221 of the bore 203a of the tensioner housing 203. The retainer 233 of the check valve assembly 220 receives a ball 234 which can move within the retainer to seat on and off of a valve seat 235. The shape of the retainer 233 is not limited to the shape shown in the drawings. Furthermore, the ball 234 can be another shape such as a disk or cup and is not limited to the shape shown in the drawings.

In a closed position of the check valve assembly 220, fluid is prevented from entering the high pressure chamber 208 by the ball 234 seating on the valve seat 235. In an open position, the ball 234 unseats from the check valve 235, unblocking a hole 238 in the retainer 233, such that fluid in the internal reservoir 241 can flow around the ball 234 and into the high pressure chamber 208.

When pressure in the internal reservoir 241 is greater than the pressure in the high pressure chamber 208, the pressure of the internal reservoir 241 flows through the hole 252 of the internal divider 251 to bias the moveable ball 234, allowing fluid from the internal reservoir 241 to flow into the high pressure chamber 208.

Fluid from a supply flows from an inlet 205 to the inlet portion 248 of the bore 203a and to the inlet 240 of the hollow piston 204. The fluid fills the internal reservoir 241 of the hollow piston 204. When the fluid in the internal reservoir 241 is of a pressure which is greater than the pressure in the high pressure chamber 208, fluid flows through the hole 252 in the internal divider 251 and a hole in the retainer 233 into the high pressure chamber 208. Backflow from the high pressure chamber 208 to the internal reservoir 241 is prevented by ball 234. Fluid from the internal reservoir 241 can enter the high pressure chamber 208 when the pressure in the high pressure chamber 208 falls due to extension of the piston 204 outwards from the housing 203 (increasing the volume of the high pressure chamber 208), drawing fluid into the high pressure chamber 208 from the internal reservoir 241.

When the piston 204 is pushed towards the tensioner housing 203 in response to a pulse from the chain or belt, the pressure in the high pressure chamber 208 increases to react to the force applied from the chain. This pressure can be tuned to react to a known force to control the timing drive.

In any of the above embodiments, the amount of leakage allowed by the check valve assembly 120, 220 between the high pressure chamber 108, 208 and the internal reservoir 141, 241 can vary, varying the tensioner stiffness.

In the above embodiments, the position of the reservoir hole 140, 240 is on the downside (below) the center plane C-C of the piston 104, 204 relative to the oil inlet 105, 205 to increase the oil retention within the internal reservoir during engine shutdown, reduce start up noise and decrease air from accumulating within the internal reservoir 140, 240.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic tensioner for tensioning an endless loop flexible power transmission member comprising:
a housing defining a closed end bore having an inlet portion connected to a supply of oil through an oil inlet hole;
a hollow piston to contact the endless loop flexible power transmission member slidably received within the closed bore, the hollow piston comprising a body defining an internal bore, the body having a first end, a second end, and a reservoir hole in fluid communication with the internal bore and the oil inlet hole through the inlet portion of the closed end of the bore;
a check valve assembly received within the internal bore of the hollow piston;
an internal reservoir defined by the internal bore of the body of the hollow piston and the check valve assembly; and
a high pressure chamber defined by the check valve assembly, the internal bore of the hollow piston, and the closed end of the bore;
wherein the reservoir hole is downside of a center plane of the hollow piston.

2. The tensioner of claim 1, further comprising a spring within the high pressure chamber with a first end of the spring contacting the check valve assembly and a second end of the spring contacting the closed end of the bore.

3. The tensioner of claim 1, wherein the reservoir hole is in fluid communication with the internal reservoir.

4. The tensioner of claim 1, further comprising a vent hole in the first end of the body of the hollow piston.

5. The tensioner of claim 1, further comprising a vent disk received within the internal bore of the hollow piston at the first end.

6. The tensioner of claim 1, further comprising a washer adjacent the check valve assembly received within the internal reservoir.

7. The tensioner of claim 1, wherein the body further comprises an internal divider between the first end and the second end, the internal divider further defining the internal reservoir.

8. The tensioner of claim 7, wherein the internal divider has a hole.

9. The tensioner of claim 7, further comprising a cap to contact the endless loop flexible power transmission member received within the first end of the body.

10. The tensioner of claim 1, wherein the check valve assembly further comprises a retainer, a moveable member, and a valve seat on the retainer in which the moveable member seats upon, the moveable member having a first position in which the moveable member seats on the valve seat and a second position in which the moveable member does not seat on the valve seat, such that fluid can flow from the internal reservoir to the high pressure chamber through the retainer.
